(19) United States
(12) Patent Application Publication
(10) Pub. No.: US 2026/0267061 A1
(43) Pub. Date: Sep. 10, 2026

(54) OPTICAL INTERPOSER

(71) Applicant: Enosemi, Inc., Sacramento, CA (US)

(72) Inventors: Shahab Ardalan, San Jose, CA (US); Ari Novack, Seattle, WA (US); Matthew Streshinsky, Taos, NM (US)

(21) Appl. No.: 19/074,954

(22) Filed: Mar. 10, 2025

(51) Int. Cl. G02B 6/12; H04B 10/80

(52) U.S. Cl. CPC G02B 6/12004; H04B 10/801

(57) ABSTRACT

A device comprising: a computer computational device; a plurality of memory modules; and an interposer configured for providing a parallel communication bus including a plurality of optical links between the computer computational device and the memory modules. Each optical link includes a compact modulator that does not rely on resonance, which yields extremely low-power tuning, simple control, and temperature stability, and a matching electro-optic receiver with an integrated TIA co-designed with the transmitter.

### TECHNICAL FIELD

The present disclosure relates to high-speed interconnects between computer systems and high-bandwidth memory (HBM) modules, and in particular to an optical interposer for coupling computer systems to HBM.

### BACKGROUND

Next-generation computer-memory interfaces will utilize multiple thousands of high-speed interconnects, e,g. greater than two Terabytes/s with more than three Tbps/mm of bidirectional bandwidth and bandwidth density. Existing electrical interposers provide insufficient metal traces to enable this bandwidth growth. Integrated silicon photonic interposers are an attractive alternative to integrated active electronic interposers by enabling distance-invariant communication with ultra-small footprints. The primary limitation to using silicon photonic interposers has been two-fold: (1) Only resonant devices have been demonstrated with compact-enough footprints to match the bandwidth density of electrical links, and (2) the power consumption of electronic-photonic-electronic links are multiple times higher than electrical-only variants, even when considering the additional power from electrically retimed devices for short-reach interconnects.

An object of the present disclosure is to provide an optical interposer with extremely compact footprint modulators and receivers, without requiring resonant devices, which can be directly driven for high-bandwidth-density low-power connectivity.

### SUMMARY

Accordingly, a first apparatus include a device comprising: a computer computational device; a plurality of memory modules; and an interposer configured for providing a parallel communication bus including a plurality of optical links between the computer computational device and the memory modules; wherein each of the plurality of optical links comprises: a modulator, an optical waveguide, and a photodetector.

In any of the above embodiments, each modulator may comprise a variable optical attenuator (VOA) including a forward biased PIN diode.

In any of the above embodiments, each forward biased PIN diode may include a serpentine waveguide structure.

In any of the above embodiments, the plurality of optical links may comprise a plurality of serpentine waveguide structures configured into an array of serpentine waveguide structures.

In any of the above embodiments, each of the plurality of optical links may include an equalizer configured to compensate for a bandwidth limitation of the forward-biased PIN diode due to carrier recombination lifetime.

In any of the above embodiments, the equalizer may comprise a continuous time linear equalizer (CTLE).

In any of the above embodiments, the CTLE may comprise a differential amplifier including a degeneration resistor, and an active capacitor configured to adapt to different channel conditions in the differential amplifier.

In any of the above embodiments, the CTLE may also comprises a coupled inductor network configured to compensate for parasitic capacitances.

In any of the above embodiments, the equalizer may be positioned after the photodetector.

In any of the above embodiments, the equalizer may be positioned before the modulator.

In any of the above embodiments, each modulator may comprise a Mach Zehnder modulator including a phase shifter including a forward-biased PIN diode.

In any of the above embodiments, each forward biased PIN diode may include a serpentine waveguide structure.

In any of the above embodiments, the plurality of optical links may comprise a plurality of serpentine waveguide structures configured into an array of serpentine waveguide structures.

In any of the above embodiments, each of the plurality of optical links may include an equalizer configured to compensate for a bandwidth limitation of the forward-biased PIN diode due to carrier recombination lifetime.

In any of the above embodiments, the equalizer may comprise a continuous time linear equalizer (CTLE).

In any of the above embodiments, the CTLE may comprise a differential amplifier including a degeneration resistor, and an active capacitor configured to adapt to different channel conditions in the differential amplifier.

In any of the above embodiments, the equalizer may be positioned after the photodetector.

In any of the above embodiments, the equalizer may be positioned before the modulator.

In any of the above embodiments, the plurality of optical links may comprise at least 1024 optical links.

In any of the above embodiments, the plurality of optical links may comprise at least 2048 optical links.

### BRIEF DESCRIPTION OF THE DRAWINGS

Some example embodiments will be described in greater detail with reference to the accompanying drawings, wherein:

FIG. 1 is a side view in accordance with an example optical device of the present disclosure;

FIG. 2 is a plan view of an optical interposer of the optical device of FIG. 1;

FIG. 3A is an schematic diagram of an optical link of the optical device of FIG. 1;

FIG. 3B is an schematic diagram of an optical link of the optical device of FIG. 1;

FIG. 3C is an schematic diagram of an optical link of the optical device of FIG. 1;

FIG. 3D is an schematic diagram of an optical link of the optical device of FIG. 1;

FIG. 4A is a plan view of a portion of the optical interposer of the device of FIG. 1;

FIG. 4B is a plan view of a portion of the optical interposer of the device of FIG. 1;

FIG. 4C is a plan view of a portion of the optical interposer of the device of FIG. 1;

FIG. 5 is a cross-sectional view of a modulator of the optical link of FIG. 3C or 3D;

FIG. 6A is a cross-sectional view of a modulator of the optical link of FIG. 3A or 3B;

FIG. 6B is a schematic diagram of a continuous-time linear equalizer;

FIG. 7 is a side view in accordance with an example optical device of the present disclosure;

FIG. 7 is a side view in accordance with an example optical device of the present disclosure; and

FIG. 8 is a plan view in accordance with an example optical device of the present disclosure.

FIG. 9 is a schematic view in accordance with an example optical device of the present disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

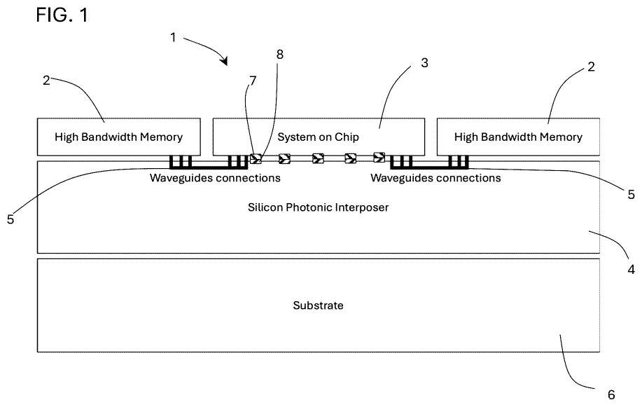

With reference to FIG. 1, an exemplary computer system 1 comprises one or more high-bandwidth memory (HBM) modules 2, e.g. DRAM memory stack with through-silicon vias (TSVs), and a computer computational device (chip) 3, e.g. in the form of a system on chip (SoC) interconnected by an optical interposer 4, which provides a parallel communication bus via a plurality of optical links 5 between the computer computational device 3 and the memory modules 2. The computer system 1 can includes a substrate 6 on which the computer system 1 is mounted. The computational computer device 3, e.g. the SoC, can be flip chip bonded onto the interposer 4 with corresponding micro-bumps 7 on the computer computational device 3 and micro solder bumps 8 on the optical interposer 4 soldered together, though the specifics of the interconnect between the two dies (the SoC 3 and the optical interposer 4) is flexible, e.g. copper pillars, micro-bumps, copper-copper bonding, etc. The optical interposer 4 to HBM 2 connections should be electrical, though there are possible exemplary embodiments in which the die at the bottom of the stack of HBM 2 is optical and the optical interposer 4 is purely optical routing and switching

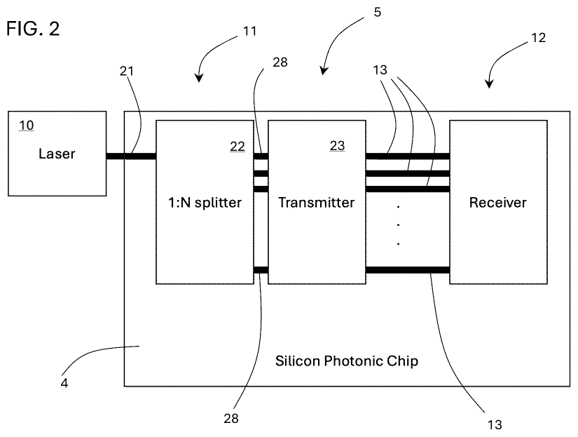

With reference to FIG. 2, the optical interposer 4 includes the plurality of optical links 5 configured for transmitting requests and data in the form of optical signals between the computer computational device 3 and the memory modules 2. Each optical link 5 comprises one or more lasers 10, a transmitter 11 and a receiver 12 optically coupled with an optical link waveguide 13. Each transmitter 11 includes a laser output waveguide 21, a splitter 22, a modulator 23, and a transmitter SERDES 24 with a driver 25. Each receiver 12 comprises a photodetector (PD) 31, a transimpedance amplifier (TIA) 32, and a receiver SERDES 33. In some embodiments, one or more equalizers 35, e.g. continuous time linear equalizers (CTLE) are provided in the transmitter 11 and/or the receiver 12.

The electrical connection between the modulator 23 and the HBM module 2 or the SoC 3, and between the PD 31, the TIA 32, and the HBM module 2 or the SoC 3 do not require a fan out or a gearbox device to aggregate multiple data channels into one electrical connection.

In some embodiments, the one or more lasers 10 is a single laser 10, which is divided multiple times, e.g. 1024-2048, by the splitter 22 onto splitter output waveguides 28 on the interposer 4. As an example, if the receiver 12 has an on-chip power sensitivity of —20 dBm at 10 Gbps, with 5 dB of excess loss in the laser-waveguide coupling, the transmitter 11, and other optical components, then an 18 dBm laser could support 2048 parallel transmit channels (log 2(2048)×3 dB−20+5). Distributed feedback DFBs lasers with more than 18 dBm of output power are widely available today. The laser(s) 10 could be integrated into the interposer 4, next to the interposer 4, or in a separate package with an optical fiber placed between the laser 10 and the interposer 4.

Due to the very high bandwidth densities offered by on-chip single-mode optical link waveguides 13, no multiplexing on the interposer 4 is required. In contrast, typical fiber-coupled systems with single-mode fibers in a row will be limited by placing optical fibers at 127 μm of 250 μm fiber-to-fiber pitch, in which case the shoreline density is limited to the bandwidth per fiber divided by 127 μm or 250 μm.

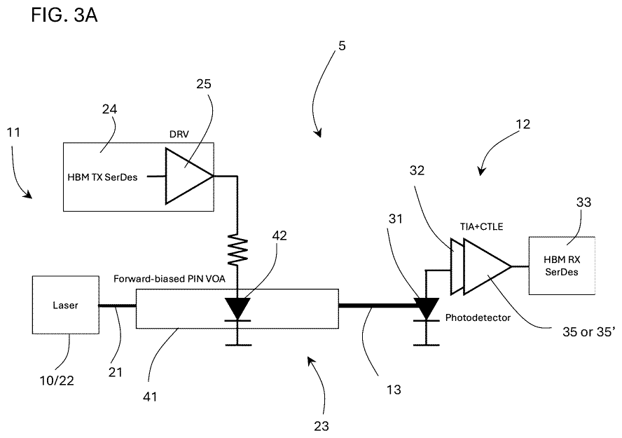

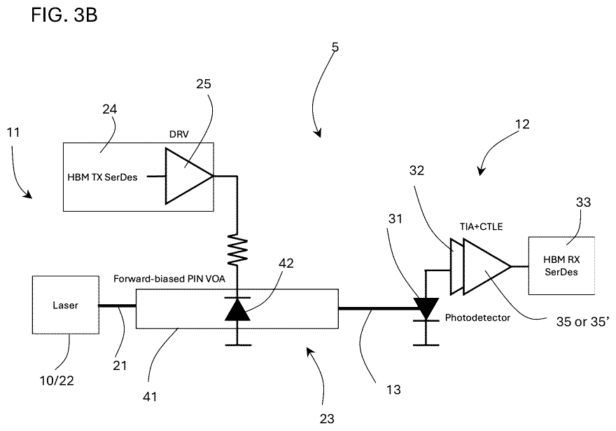

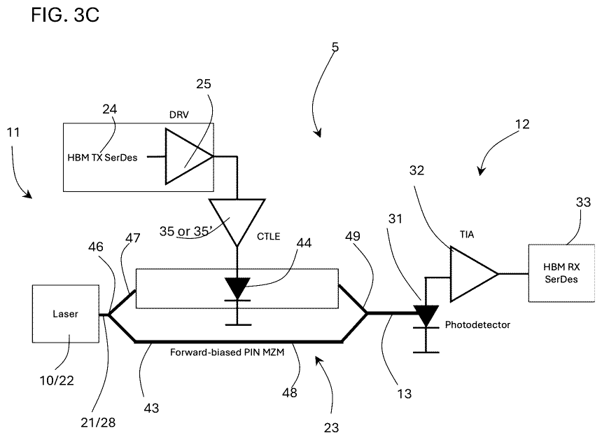

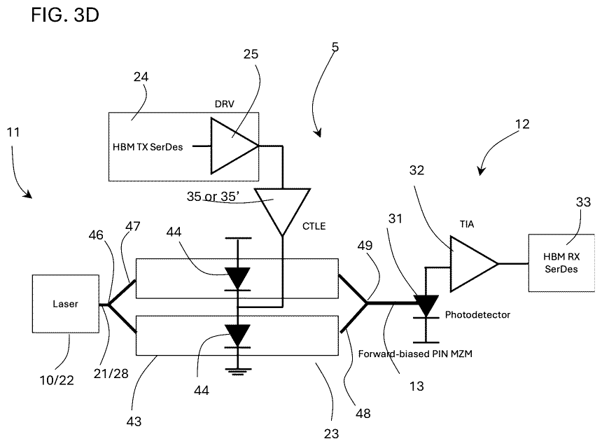

With reference to FIGS. 3A to 3D, exemplary modulators 23 includes a variable optical attenuator (VOA) 41 (FIGS. 3A and 3B), e.g. in the form of a PIN diode 42, such as silicon, and a Mach-Zehnder modulator (MZM) 43 (FIGS. 3C and 3D), e.g. in the form of a PIN diode 44, such as silicon, used as a phase shifter. In each case, the equalizer circuit 35 is configured to compensate for the bandwidth limitation of forward-biased silicon PIN diodes 42 and 44 due to carrier recombination lifetime. For linear systems, the equalizer 35 can be placed in one or more places in the optical link 5, e.g. before the transmitter 11 electrically (FIGS. 3C and 3D), between the transmitter 11 and the receiver 12 with an optical equalizer 35, or after the receiver 12 electrically (FIGS. 3A and 3B).

The VOA 41 has an advantage in not requiring the additional phase tuning that the MZM 43 requires. The VOA 41 also has the advantage of being able to position the equalizer 35 either at the transmitter 11, the receiver 12, or both. In contrast, the transmitter 11 using an MZM 43 must place the majority of pre-emphasis before the MZM 43 since the equalization at the receiver 12 will be limited in compensating up to an effective π phase shift, when biased at quadrature, due to the sinusoidal response, e.g. if the DC level of modulation is targeted at π/2 of the phase shift, then 6 dB of RX equalization would enable the transmitter 11 to drive with a π phase shift. The VOA 41 has a disadvantage in that it requires a larger change in forward-current to achieve similar extinction to the MZM 43.

When a forward-biased PIN diode 44 is used as the phase shifter in the Mach-Zehnder modulator 43, the modulator efficiency can be as good as 0.0025 V·cm. A 50 μm-long device would have a Vπ of 0.5V. More directly though, a forward-biased PIN junction modulates phase by modulating the forward current through the computer system 1. Typical forward phase vs. current relationships are approximately π radians per mA.

A non-return to zero (NRZ) modulator should only require ~1.5 radians to achieve a very good extinction ratio (7 dB) when biased at quadrature. From the above data, it should be possible to drive a PIN modulator 23 with ~0.5mA for a ~250 μm long device. With 10 dB of RF loss, if we drive 0.5V into 50Ω, we can get ~10 mA, which can be equalized down to ~3 mA. Significantly more swing than is required for a good NRZ data pattern.

The forward-biased silicon PIN diode 42 can also be used directly as the modulator 23 by directly modulating the optical transmission in a modulator waveguide 45 between the splitter output waveguide 28 and the optical link waveguide 13. In this case, a 250 μm length VOA 41 can achieve >5 dB of extinction with 5 mA of forward current modulation. If the loss to be compensated for at Nyquist is approximately 10-15 dB, then over-emphasizing the input at high frequencies to 15 to 30 mA would still enable a 5 dB extinction transmitter 11.

FIG. 3A illustrates an example optical link 5 in which the silicon PIN diode 42 is configured as the VOA 41; however, depending on the design of the output of the SerDes driver 2535, it may be more advantageous to sink current into the driver 25, in which case the polarity of the PIN diode 42 should be reversed, as in FIG. 3B.

With reference to FIGS. 3C and 3D, the modulator waveguide 45 of the MZM 43 comprises an input splitter 46 coupled to the laser output waveguide 21 or the splitter output waveguide 28 for splitting the optical signal into two equal sub-beams on a first arm 47 and a second arm 48. In some embodiments the MZM 43 is driven with a PIN diode 44 in a single arm, e.g. the first arm 47, of the MZM 43 with nothing in the other arm, e.g. the second arm 48, while in some embodiments the MZM 43 is driven differentially with a PIN diode 44 in each of the first and second arms 47 and 48. A output splitter 49 recombines the two sub-beams into a modulated output optical signal for coupling to the corresponding optical link waveguide 13.

Avalanche photodetectors can also be used for the photodetectors 31 to improve the sensitivity of the receiver 12.

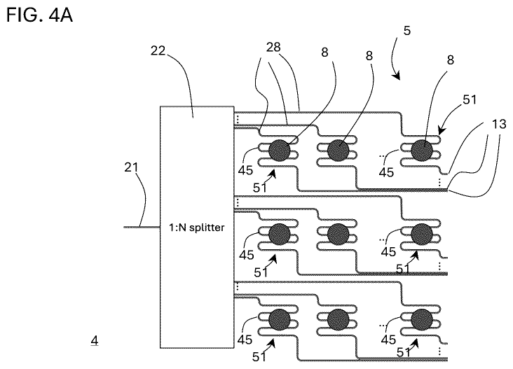

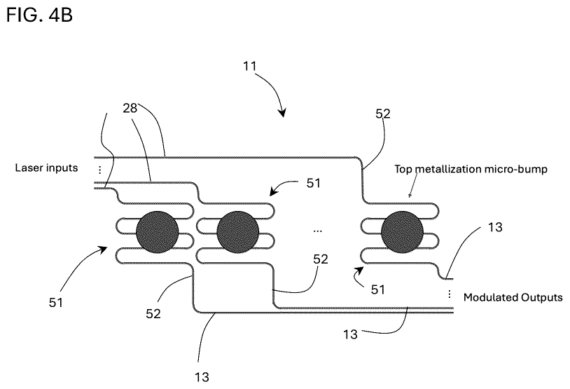

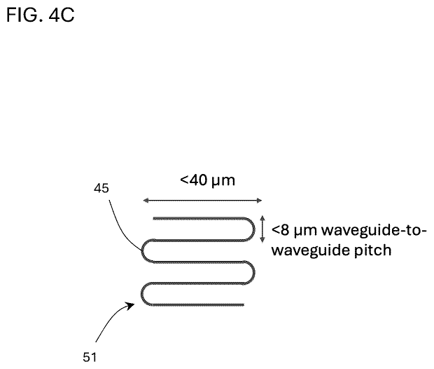

With reference to FIGS. 4A to 4C, each of the modulator waveguides 45 comprises one of a plurality of serpentine waveguide structures 51 is positioned between each respective splitter output waveguide 28 and each corresponding optical link waveguide 13. The plurality of serpentine waveguide structures 51 are formed into a linear array including a plurality of rows of serpentine waveguide structures 51 and a plurality of columns of serpentine waveguide structures 51. For each row of serpentine waveguide structures 51, each of the splitter output waveguides 28 has a different length and each of the optical link waveguides 13 has a different length enabling the serpentine waveguide structures 51 to be positioned adjacent to each other in the respective row. Each of the serpentine waveguide structures 51 comprises a plurality of straight sections, e.g. 4-8 straight sections, extending 30 μm to 60 μm long and parallel to each other, interconnected in a continuous length by one of a plurality of curved sections, e.g. 3-7 curved sections, extending between straight sections with a 5 μm to 10 μm diameter. A single row of the serpentine waveguide structure 51 could be cascaded in which in each 30 μm to 60 μm wide row, ⅓ of the area is for the splitter output waveguides 28, ⅓ is for the modulator 23 (under the micro solder bump 8), and ⅓ is for the optical link waveguides 13. A plurality of rows or serpentine waveguide structures 51 forming an array of the serpentine waveguide structures 51 could be assembled to form the transmitter 11, with e.g. 1024, 2048, or more parallel channels.

Each row of serpentine waveguide structures 51 includes a plurality of the splitter output waveguides 28 extending parallel to each other from the splitter 22, a respective one of the splitter output waveguides 28, each with different lengths, extending to a corresponding one of the serpentine waveguide structures 53 in the row. Each row of serpentine waveguide structures 51 also includes a plurality of optical link waveguides 13 extending parallel to each other from the receiver, a respective one of the optical link waveguides 13, each with a different length, extending from a corresponding one of the serpentine waveguide structures 51 in the row. Each row of serpentine waveguide structures 51 also includes a plurality of curved and connecting waveguide structures 52, i.e. one or more in each modulator waveguide 45, configured to extend from the splitter output waveguides 28 and to the optical link waveguides 13 to enable the serpentine waveguide structures 51 to be positioned adjacent one another in row.

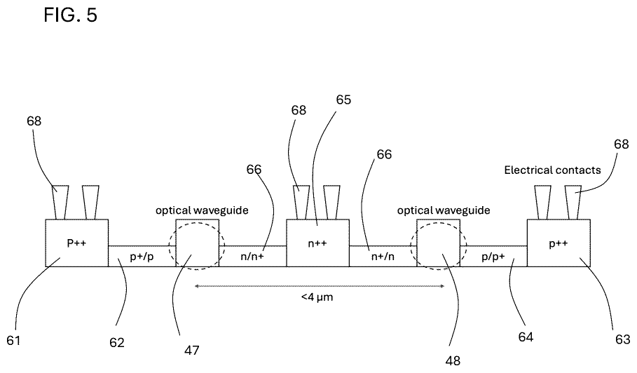

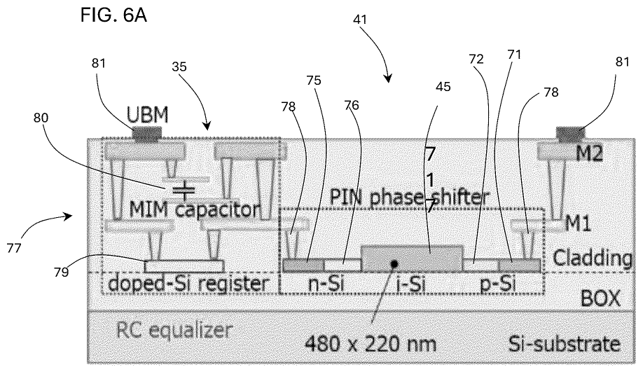

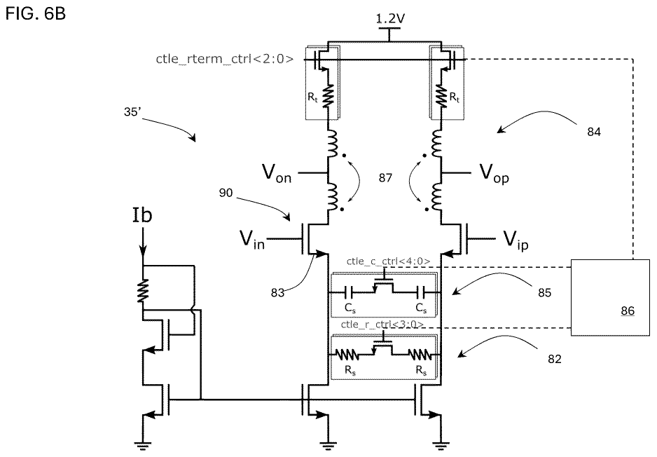

Accordingly, a long silicon PIN diode, e.g. 200 μm-300 μm long, can be embedded in the serpentine waveguide structure 51 for a MZM 43 formed in one of the serpentine waveguide structures 51. An example cross-sectional diagram of the PIN diode 44 is illustrated in FIGS. 5 and 6. For the MZM 43, see FIG. 5, the first waveguide arm 47 has a first ground (highly P++ doped) electrode 61 extending along one side thereof with a moderately P+ doped section 62 therebetween. The second waveguide arm 48 has a second ground (highly P++ doped) electrode 63 extending along one side thereof with a moderately P+ doped section 64 therebetween. The signal electrode 65, e.g. highly N++ doped, extends in between the first waveguide arm 47 and the second waveguide arm 48, with moderately N+ doped sections 66 extending between the signal electrode 65 and the first and second waveguide arms 47 and 48. Electrical contacts 68 extend upwardly from the first ground electrode 61, the second ground electrode 63 and the signal electrode 65 for transmitting electrical signals. Other signal and ground electrode configurations are possible depending on the application, e.g. signal-ground-ground-signal, signal-ground-signal, signal-ground-signal-ground-signal etc.

For the VOA 41, see FIG. 6A, the modulator waveguide 45 has a ground (highly P++ doped) electrode 71 extending along one side thereof with a moderately P+ doped section 72 therebetween. A signal electrode 75, e.g. highly N++ doped, extends along an opposite side of the modulator waveguide 45, with moderately N+ doped sections 76. Electrical contacts 78, e.g. vertical and horizontal vias, extend upwardly from the ground electrode 71 and the signal electrode 75 for transmitting electrical signals.

With reference to FIG. 6B, a Continuous-Time Linear Equalizer (CTLE) is a component in high-speed data communication systems, particularly in SerDes (Serializer/Deserializer) designed to compensate for frequency-dependent losses that occur due to various factors such as: a) Skin effect: At high frequencies, current tends to flow near the surface of conductors, increasing resistance and signal attenuation; b) Dielectric losses: The insulating material in PCB traces and cables introduces frequency-dependent losses; c) Inter-symbol interference (ISI): Lossy channels cause signal components at different frequencies to spread out in time, distorting the signal; and d) Crosstalk and reflections: Higher frequencies experience more pronounced interference and reflections due to impedance mismatches.

To counteract these losses, a CTLE equalizer 35′ boosts the high-frequency components of the signal while maintaining a relatively flat response at lower frequencies, which restores signal integrity and enables higher data rates over longer distances. When the CTLE active equalizer 35′ is positioned in the transmitter 11 with the modulator 23, as in FIGS. 3C and 3D, the output connections “Von” and “Vop”, i.e. a differential pair, seen in FIG. 6B are connected to the electrical contacts 68, of the PIN diode in FIG. 5. When CTLE active equalizer 35′ is placed after the modulator 23 (FIGS. 3A & 3B) at the receiving end to compensate for the modulator 23. In this case, The “Vin” and “Vip” terminals would be connected to the output of a transimpedance amplifier 32. The equalizer at the receiving end is still compensating for the low bandwidth of the PIN)

Equalizing a forward-biased PIN VOA 41 typically comprises a passive resistor and capacitor circuit 77 (FIG. 6A) including a passive resistor 79 and passive capacitor 80, connected between the electrical contacts 78 and the under bump metallization (UBM) 81. Rather than a purely passive equalizer circuit, some embodiments of the present invention includes an active circuit equalizer 35′ (FIG. 6B) that enables tunability, a compact footprint, and wider achievable bandwidths. It is possible to build a compact active equalizer 35′ in a 45 nm CMOS process with 10 dB or more of equalization. For example, a tunable 10 dB tunable equalizer design will fit within a 40×40 μm² bump pad pitch array. The active equalizer 35′ comprises an optical equalizer comprising a combination of at least one or more of: an unbalanced Mach-Zehnder interferometer, a resonant cavity, a multimode interferometer. A tunable continuous-time linear (CTLE) active equalizer 35′ which can be either placed at the transmitter 11 or in the receiver 12 or both. Accordingly, the CTLE active equalizer 35′ and the modulator 23 can be placed at a 40 μm electrical contact pitch and driven directly by a physical layer interface (PHY) of the HBM module 2. For example, the PD 31, the TIA 32 and the CTLE equalizer 35 can be placed at a 40 μm electrical contact bump pitch, e.g. under each of the micro solder bumps 8, and received by an HBM PHY. The silicon photonic chip assembly, together with an SOC 3 and the HBM module 2 does not require any changes to the existing HBM PHY design.

The CTLE active equalizer 35′ includes an adjustable degeneration resistor 82 and an adjustable capacitor 85, placed at the source connection 83 of a MOSFET 90 or at the emitter of a BJT if a bipolar transistor technology is used instead of a MOSFET transistor (not shown). High-frequency gain peaking occurs because, at low frequencies, the adjustable capacitor 85 acts as an open circuit, allowing the adjustable degeneration resistor 82 to dominate and reduce gain. However, at higher frequencies, the adjustable capacitor 85 acts as a short circuit, bypassing the adjustable degeneration resistor 82 and restoring gain. This introduces a zero in the frequency response, enabling selective high-frequency amplification that helps counteract channel losses. The CTLE active equalizer 35′ also may include an inductor, such as the T-coils 87 placed in series with the output load. The T-coil may compensate for parasitic capacitances and further extend the circuit's bandwidth.

Resistive degeneration is a technique used in the CTLE active equalizer 35′ to modify the frequency response, primarily by introducing a degeneration resistor 82 in the emitter (BJT) or the source 83 (MOSFET) of a differential amplifier 84. Resistive degeneration offers several key benefits, one of which is gain control. Without degeneration, the amplifier gain is highly dependent on transistor transconductance, which varies with temperature and process variations. By introducing the degeneration resistor 82 in the source 83 or the emitter, the effective transconductance is reduced, resulting in a more controlled and stable gain. Another significant benefit is improved linearity. Nonlinearities in the transistor's voltage-current characteristics can introduce signal distortion. The degeneration resistor 82 provides negative feedback, which helps linearize the differential amplifier 84 and reduce distortion, ultimately improving signal fidelity.

Additionally, resistive degeneration contributes to bandwidth expansion. The degeneration resistor 82 lowers the low-frequency gain, thereby reducing the impact of unwanted low-frequency components. This extends the overall frequency response, ensuring a better balance between low-and high-frequency signal components. While resistive degeneration alone reduces gain and improves linearity, it does not directly provide high-frequency equalization, which is essential for loss compensation. To address this, an active capacitor 85 is placed in parallel with the degeneration resistor 82, forming a frequency-dependent impedance. High-frequency gain peaking occurs because, at low frequencies, the active capacitor 85 acts as an open circuit, allowing the degeneration resistor 82 to dominate and reduce gain. However, at higher frequencies, the active capacitor 85 acts as a short circuit, bypassing the degeneration resistor 82 and restoring gain. This introduces a zero in the frequency response, enabling selective high-frequency amplification that helps counteract channel losses.

Adaptive equalization is another advantage, as the values of the degeneration resistor 82 and the active capacitor 85 can be adjusted or dynamically tuned by a controller 86 connected to the degeneration resistor 82, the active capacitor 85, and the differential amplifier 84 in certain continuous-time linear equalizer (CTLE) designs to adapt to different channel conditions. CTLE is particularly beneficial in multi-gigabit communication standards, where channels may exhibit varying loss characteristics.

Some embodiments also use T-Coil inductive peaking to enhance bandwidth, which is a technique used in the differential pair amplifier 84 to enhance bandwidth and improve high-frequency performance. T-Coil inductive peaking comprises placing a coupled inductor network (T-Coil) 87 in series with the load R_{T} to compensate for parasitic capacitances and extend the amplifier's frequency response.

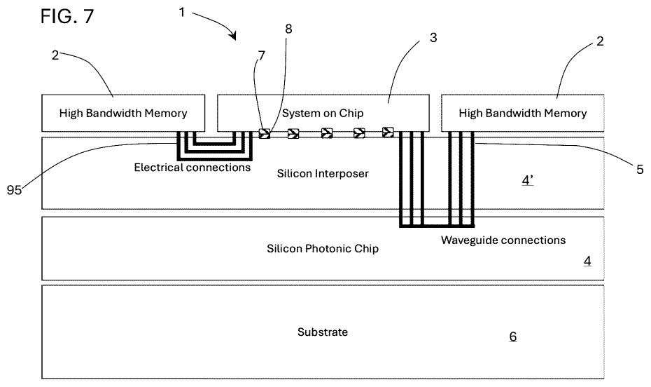

FIG. 7 illustrates an alternative exemplary embodiment in which a first interposer 4 is configured to communicate with one or more HBM modules 2, while a second interposer 4′, superposed on the first interposer 4 is configured to communicate with one or more other HBM modules 2. In particular, the first interposer 4 may be configured to communicate with optical links 5, while the second interposer 4′ is configured to communicate with electrical connections 95. The optical links 5 or the electrical connections 95 may be configured to extend through the other interposer, e.g. the first interposer 4 or the second interposer 4′.

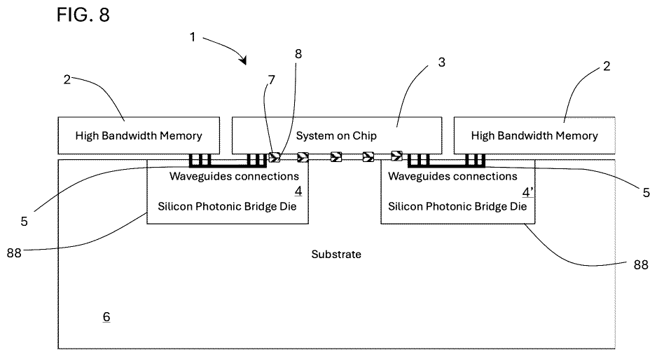

FIG. 8 illustrates an alternative exemplary embodiment in which a first interposer 4 is configured to communicate with a first one or more HBM modules 2, while a second interposer 4′, adjacent to the first interposer 4 is configured to communicate with a second one or more other HBM modules 2. In particular, the first interposer 4 may be configured to communicate with optical links 5, while the second interposer 4′ is configured to communicate with electrical connections 95. The first interposer 4 is configured to only extend underneath a portion of the SoC 3 and a portion of the first one or more HBM modules 2, while the second interposer 4′ is configured to only extend underneath a portion of the SoC 3 and a portion of the second one or more HBM modules 2. The substrate 6 may be configured, e.g. etched, to include cavities 88 for receiving the first interposer 4 and the second interposer 4′.

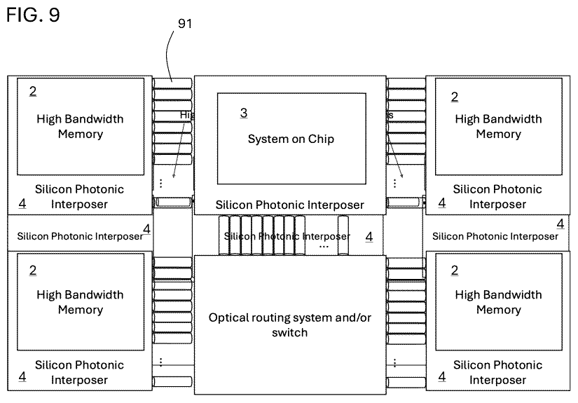

With reference to FIG. 9, the chip to chip connections between the SoC 3 and the HBM modules 2 can also be facilitated with optical chip-to-chip interconnects 91. In this way, each silicon photonic chip needs to only be large enough to support one SoC 3 or HBM module 2. Optical fibers or fiber arrays can be used as the optical chip-to-chip interconnects 91, as well as photonic wirebonds, additional integrated photonic chips with waveguiding layers, or free space optical assemblies. High-density optical chip-to-chip interconnects will enable this system to scale to very large SoC-HBM assemblies. Accordingly, any one interposer 4 could communicate to another interposer 4, e.g. via optical fiber, polymer waveguides, glass substrates with integrated waveguides, photonic wirebonds, lens systems, by direct edge-to-edge die placement, or some combination of these)

The foregoing description of one or more example embodiments has been presented for the purposes of illustration and description. It is not intended to be exhaustive or to limit the invention to the precise form disclosed. Many modifications and variations are possible in light of the above teaching. It is intended that the scope of the disclosure be limited not by this detailed description.

We claim:

1. A device comprising:
a computer computational device;
a plurality of memory modules; and
an interposer configured for providing a parallel communication bus including a plurality of optical links between the computer computational device and the memory modules;
wherein each of the plurality of optical links comprises: a modulator, an optical waveguide, and a photodetector.

2. The device according to claim 1, wherein each modulator comprises a variable optical attenuator (VOA) including a forward biased PIN diode.

3. The device according to claim 2, wherein each forward biased PIN diode includes a serpentine waveguide structure.

4. The device according to claim 3, wherein the plurality of optical links comprises a plurality of serpentine waveguide structures configured into an array of serpentine waveguide structures.

5. The device according to claim 2, wherein each of the plurality of optical links includes an equalizer configured to compensate for a bandwidth limitation of the forward-biased PIN diode due to carrier recombination lifetime.

6. The device according to claim 5, wherein the equalizer comprises a continuous time linear equalizer (CTLE).

7. The device according to claim 6, wherein the CTLE comprises a differential amplifier including a degeneration resistor, and an active capacitor configured to adapt to different channel conditions in the differential amplifier.

8. The device according to claim 7, wherein the CTLE also comprises a coupled inductor network configured to compensate for parasitic capacitances.

9. The device according to claim 6, wherein the equalizer is positioned after the photodetector.

10. The device according to claim 6, wherein the equalizer is positioned before the modulator.

11. The device according to claim 1, wherein each modulator comprises a Mach Zehnder modulator including a phase shifter including a forward-biased PIN diode.

12. The device according to claim 11, wherein each forward biased PIN diode includes a serpentine waveguide structure.

13. The device according to claim 12, wherein the plurality of optical links comprises a plurality of serpentine waveguide structures configured into an array of serpentine waveguide structures.

14. The device according to claim 11, wherein each of the plurality of optical links includes an equalizer configured to compensate for a bandwidth limitation of the forward-biased PIN diode due to carrier recombination lifetime.

15. The device according to claim 14, wherein the equalizer comprises a continuous time linear equalizer (CTLE).

16. The device according to claim 15, wherein the CTLE comprises a differential amplifier including a degeneration resistor, and an active capacitor configured to adapt to different channel conditions in the differential amplifier.

17. The device according to claim 14, wherein the equalizer is positioned after the photodetector.

18. The device according to claim 14, wherein the equalizer is positioned before the modulator.

19. The device according to claim 1, wherein the plurality of optical links comprises at least 1024 optical links.

20. The device according to claim 1, wherein the plurality of optical links comprises at least 2048 optical links.
